(19) United States
(12) Patent Application Publication
(10) Pub. No.: US 2012/0221961 A1
(43) Pub. Date: Aug. 30, 2012

(54) ADDRESSEE BASED MESSAGE PRIORITIZATION

(75) Inventor: Bruce Charles Reynolds, Gilroy, CA (US)

(73) Assignee: APPLE INC., Cupertino, CA (US)

(21) Appl. No.: 13/037,176

(22) Filed: Feb. 28, 2011

(51) Int. Cl. G06F 3/048; G06F 15/16

(52) U.S. Cl. 715/752

(57) ABSTRACT

Addressee based message prioritization is disclosed. In some implementations, messages received by an electronic messaging user (e.g., recipient) can be displayed in a user interface of an electronic messaging application. In some implementations, received messages can be prioritized based on how the messages are addressed to the user. In some implementations, received message can be displayed and highlighted based on the priority of each message. In some implementations, messages can be grouped and/or sorted based on the priority of each message.

### TECHNICAL FIELD

The disclosure generally relates to user interfaces for presenting electronic messages.

### BACKGROUND

The volume of electronic messages (e.g., e-mail, text messages) sent and received by users can be overwhelming. As the volume of electronic messages received by users increases, it becomes increasingly difficult to determine which messages need the highest level of attention and which messages are merely informational. Sorting by message title, author, or date received is often useless as message threads (e.g., those with the same title) can change topic and/or participants, for example. Moreover, sorting messages by title, author or date often does nothing to help the recipient-user determine which messages are important and which are not or, more specifically, which messages require the recipient's immediate attention and which do not. Thus, messages that require an immediate response from a recipient often go overlooked. Accordingly, it may be useful to prioritize messages according to how they are addressed to the recipient-user and display the messages based on priority.

### SUMMARY

Addressee based message prioritization is disclosed. In some implementations, messages (e.g., e-mails, text messages, chat messages, etc.) received by a user (e.g., recipient) can be displayed in a user interface of an electronic messaging application. In some implementations, received messages can be prioritized based on how the messages are addressed to the user. For example, messages may be prioritized based on whether the message is addressed to a user individually (e.g., directly), whether the message is addressed to the user as a member of a group (e.g., the e-mail was sent to an e-mail group), whether the message is addressed to the user as a carbon copy, or addressed to the user as a blind carbon copy. In some implementations, received messages can be displayed and/or highlighted based on the priority of each message. In some implementations, messages can be grouped and/or sorted based on the priority of each message. A method, system and computer-readable medium are disclosed for performing addressee based message prioritization.

Particular implementations provide at least the following advantages: important messages can be quickly and easily identified by a message recipient thereby improving the productivity of the message recipient and saving the recipient time that might me otherwise spent sorting through electronic messages.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example electronic message interface.

FIG. 2 illustrates an example message interface displaying messages highlighted based on priority.

FIG. 3 illustrates an example message interface displaying messages grouped and sorted based on priority.

FIG. 4 illustrates an example interface for configuring addressee based message prioritization.

FIG. 5 is flow diagram of an example message prioritization process.

FIG. 6 is a block diagram of an exemplary system architecture implementing the features and processes of FIGS. 1-5.

### DETAILED DESCRIPTION

### Overview

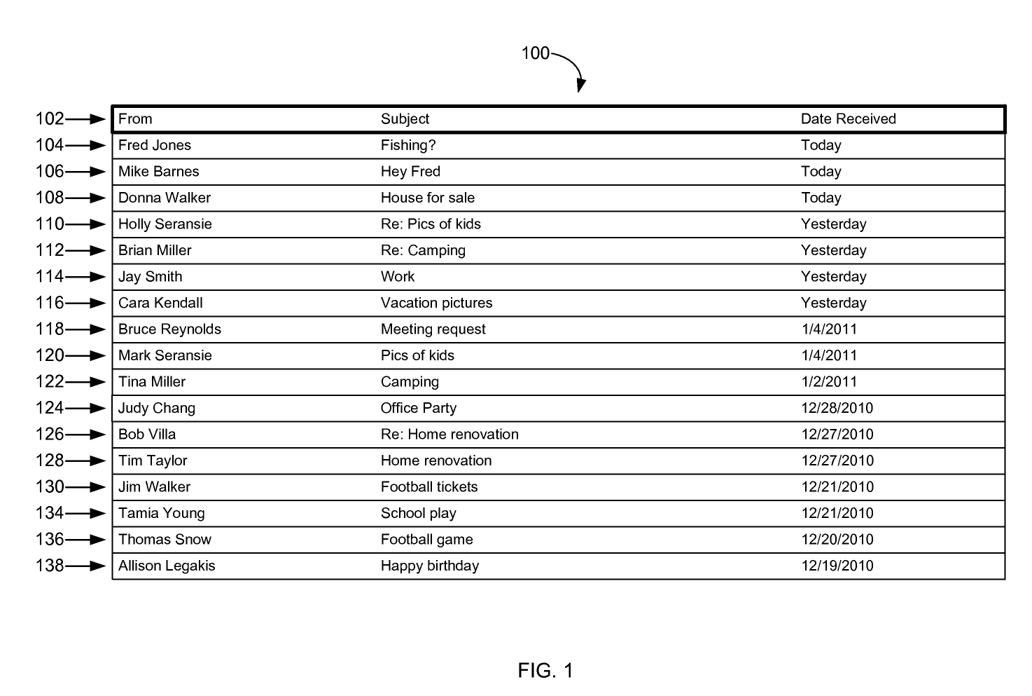

FIG. 1 illustrates an example message interface 100. Message interface 100 can display a listing of messages 104-138 received by a recipient-user. For example, message interface 100 may display e-mails that were sent to and received by an e-mail account associated with the recipient-user. Message interface 100 can include an information area 102 that displays column headings for message header data displayed in message interface 100. Message interface 100 can display a listing of received messages 104-138. Each of the displayed messages 104-138 can display message header information corresponding to the column headings included in information area 102. For example, information area 102 may include a “From” column heading, a “Subject” column heading and a “Date Received” column heading and messages 104-138 may include corresponding “From,” “Subject” and “Date Received” header fields. Message 104, for example, may display message header information indicating that message 104 is from Fred Jones, the subject of the message is “Fishing?” and that the message was received “Today.”

In some implementations, a user may indicate how to sort messages 104-138 by selecting a column heading in information area 102. For example, a user may select the “Date Received” column heading to cause messages 104-138 to be sorted by date. Selecting the “Date Received” column heading may cause the messages to be sorted in ascending or descending order by date. Likewise, the “From” and “Subject” column headers may be selected by a user to cause messages 104-138 to be sorted in ascending or descending alphabetical order by the name of a user (or the account of the user) from which the message was sent or the subject line of the message. Other column headings may be added to information area 102. For example, information area 102 may include a “Size” column for indicating a size of each message or a “Category” column for indicating a category with which each message is associated.

### Message Prioritization

According to some implementations, messages received by a user (i.e., recipient) of an electronic messaging application (e.g., e-mail client, chat client, etc.) can be prioritized according to how the messages are addressed to the user. For example, e-mails received by a particular e-mail account can be prioritized based on how the particular e-mail account is addressed in the e-mails. Messages received by a recipient may be addressed to the recipient in a variety of ways. A message may be addressed directly to the recipient. For example, the recipient's e-mail address may be listed individually in the “To” field of an e-mail. A message may be addressed to the recipient as a member of a group. For example, the recipient may be one of many addresses included in an e-mail list or group (e.g., an “Engineering,” “HR” e-mail list or group) and the e-mail may be addressed to the Engineering e-mail list in the “To” address field of an e-mail. A message may be carbon copied or blind carbon copied to the recipient.

According to some implementations, a received message can be prioritized based on how the recipient is addressed in the received message. For example, a message may be assigned a priority level (i.e., category, value) from one (1) to four (4), where a priority level of one is the highest priority and a priority level of four is the lowest priority. Other priority schemes may be used. For example, priority levels may range from zero (0) to ten (10), where ten is a high priority level and zero is a low priority level.

In some implementations, a priority can be determined for a message based on how the recipient is addressed in the message. For example, if a message is addressed directly to a recipient-user, the message may be assigned a high priority (e.g., priority level 1). If the message is addressed to the recipient-user as a member of a group, the message may be assigned a lower priority (e.g., priority level 2). If the message is carbon copied to the recipient-user, the message may be assigned a level 3 priority. If the message is blind carbon copied to the recipient-user, the message may be assigned a level 4 priority.

In some implementations, the priority levels may be configurable. For example, a recipient-user may be able to associate a priority level with the way that the recipient may be addressed in a message. For example, instead of a blind carbon copied e-mail being assigned a priority lower than a carbon copied e-mail, a recipient-user may configure the blind carbon copied e-mail to have a higher priority than the carbon copied e-mail. A recipient-user may assign an e-mail addressed to the recipient as a member of a group the lowest priority, for example.

In some implementations, messages can be displayed based on the priority determined for each message. For example, a user's inbox may display a listing of messages (e.g., a listing of header information for received e-mails or other electronic messages) and the messages may be highlighted, grouped and/or sorted according to the priority determined for the messages.

### Message Highlighting

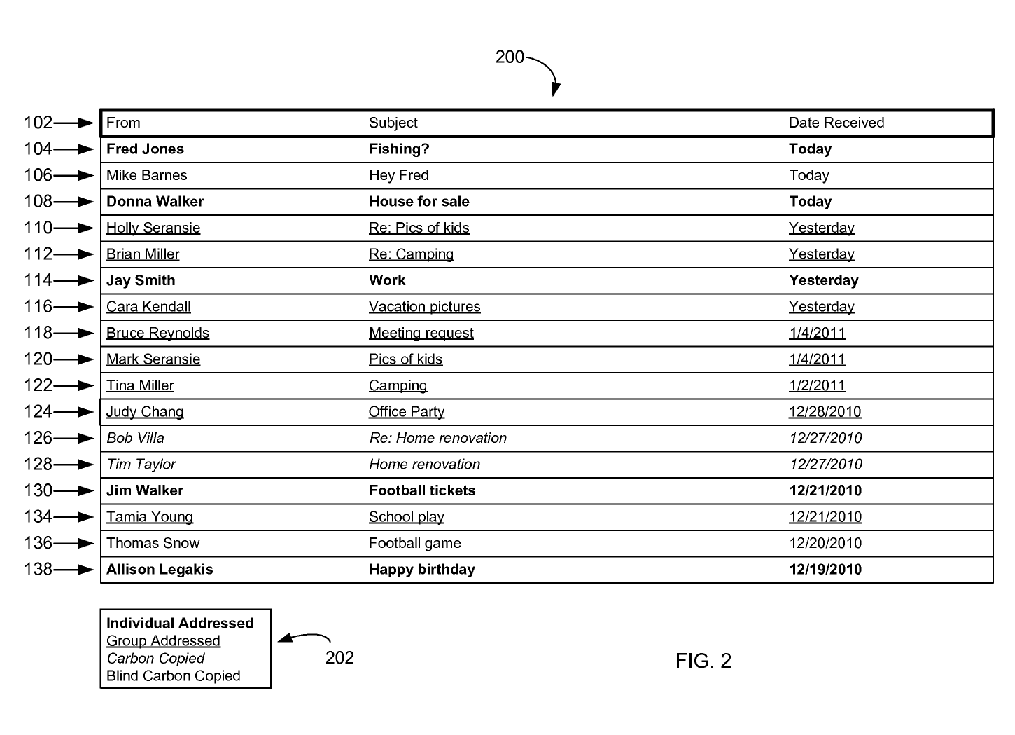

FIG. 2 illustrates an example message interface 200 displaying message header information highlighted based on a priority determined for each of the messages 104-138. For example, messages displayed in message interface 200 may be prioritized based on whether the message is addressed directly to the recipient (e.g., message 104), addressed to the recipient as a member of a group (e.g., message 110), carbon copied (CC) to the recipient (e.g., message 126) and/or blind carbon copied (BCC) to the recipient (e.g., message 106). In some implementations, message header information associated with each message and displayed in message interface 200 may be highlighted based on the determined priority.

According to some implementations, highlighting messages may be performed by formatting the text of a message header listed in message interface 200 in a particular way according to a priority determined for each corresponding message. For example, a message that is addressed directly to a recipient (e.g., the recipient is in the “To” field of the message) may be assigned a high priority. The high priority of the message may be indicated by formatting the message's header information displayed in the message listing of message interface 200 as bolded text (e.g., message 104). A message that is low priority (e.g., BCC'd to a recipient) may have no special formatting applied its header text (e.g., message 106). Other formatting, such as underlining and/or italics, may be used to highlight the text of the header information displayed for the messages in the message listing of message interface 200 (e.g., message 110, message 126).

In some implementations, formatting the text displayed for a message can include selecting a color for the text of the message header based on the priority determined for the message. In some implementations, a different format may be configured, or assigned, to each priority and the text of each message header may be formatted based on the configured, or assigned, priority-format configuration.

According to some implementations, highlighting messages may be performed by displaying a particular color in the background of a message header based on a priority determined for each message. For example, each of the message headers 104-138 listed in message interface 200 may display a background color indicating the priority of the corresponding message. A high priority message may display one color (e.g., yellow, red) while a low priority message may display another color (e.g., white, grey, etc.). A different color may be configured, or assigned, to each priority and the background of each message may be colored based on the configured, or assigned, priority-background color configuration.

In some implementations, message interface 200 may include a legend 202 that indicates the meaning of the highlighting. For example, legend 202 may indicate that bolded text indicates a high-priority message by displaying the words “High Priority” in bold text. Legend 202 may indicate that a purple background color indicates a low-priority message by presenting the words “Low Priority” on a purple background. Legend 202 may indicate that a message with underlined text is addressed to the recipient as a member of a group by displaying the words “Group Addressed” formatted as underlined text. Legend 202 may indicate that a message with a yellow background is addressed to the user directly by presenting the words “Direct Addressed” on a yellow background. Other words, textual indications, formatting, and background colors may be used, as illustrated by FIG. 2.

In some implementations, the particular highlighting (e.g., text formatting, background color) can be configured by the recipient-user. For example, the recipient may configure message interface 200 to display a red background color for messages addressed directly to the recipient. The recipient may configure message interface 200 to display green italicized text for messages that are CC'd to the recipient.

According to implementations, messages 104-138 displayed in message interface 200 may be sorted as described with reference to FIG. 1. For example, if the default sorting for messages is by date/time received, the highlighted messages may be displayed by date/time received. As new messages are received they may be displayed in message interface 200 highlighted according to their priority and in time order according to when they were received. In some implementations, a recipient-user may change the sorting of the messages by selecting one of the column headers in information area 102 as described above with reference to FIG. 1.

### Message Grouping/Sorting

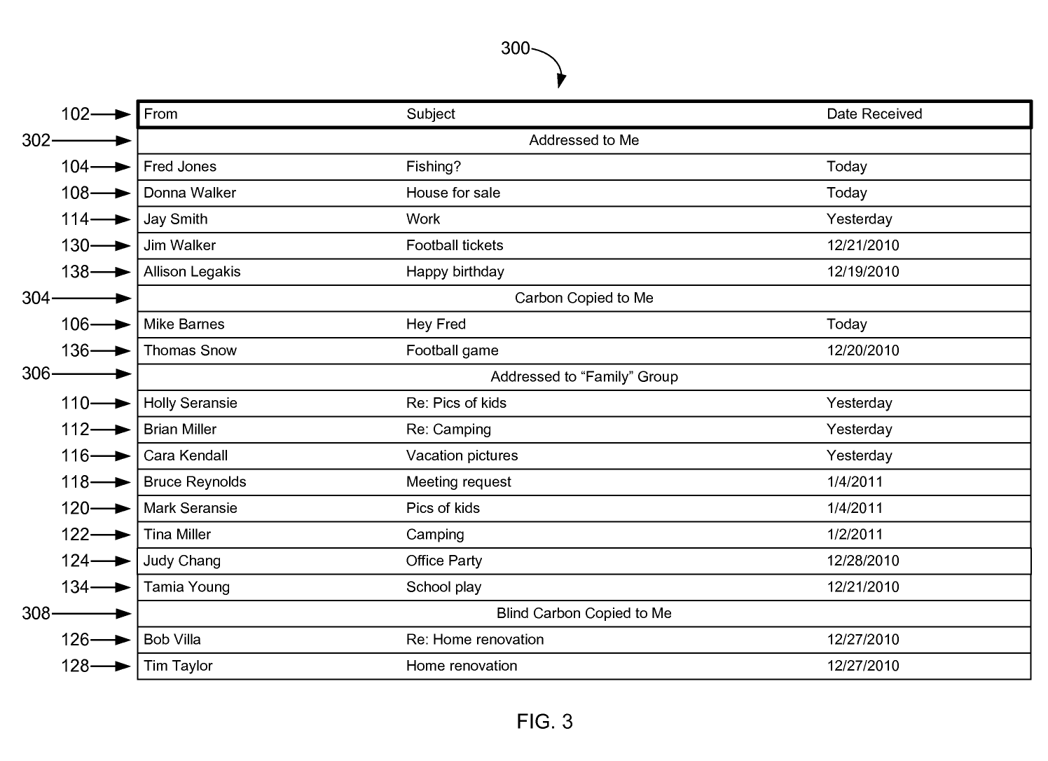

FIG. 3 illustrates an example message interface 300 with messages 104-138 grouped and sorted based on priority. According to some implementations, messages can be grouped and/or sorted according to a priority determined for each message. For example, messages 104-138 may be prioritized based on how each message is addressed to a recipient-user, as disclosed in detail above.

According to some implementations, messages 104-138 may be grouped according to a priority determined for each message. For example, high priority messages (e.g., messages 104, 108, 114, 130 and 138 addressed directly to the recipient-user) may be grouped together. In some implementations, a different message group is displayed for each priority level. Each message may be assigned to, or displayed in, a group according to the priority determined for the message.

According to some implementations, each message group can be visually distinguished from other message groups. In some implementations, each message group can be separated by group separators 302, 304, 306 and 308. Group separators 302, 304, 306 and 308 may include information identifying or describing a corresponding group. For example, group separator 302 may include a priority description (e.g., “High Priority”) or an indication of how corresponding messages 104, 108, 114, 130 and 138 are addressed to the recipient user (e.g., “Addressed to Me”). Group separators 304, 306 and 308 can include similar information as group separator 302 that identifies or describes the messages corresponding to the respective group separators (e.g., group separator 304: {messages 106, 136}; group separator 306: {messages 110, 112, 116, 118, 120, 122, 124, 134}; group separator 308: {messages 126, 128}). For example, group separators 304, 306 and 308 may display an indication of priority or a description of how corresponding groups of messages are addressed to the recipient-user.

In some implementations, each message group can be visually distinguished from other message groups by highlighting the groups of messages. For example, each message group may display a particular background color that is different from the background colors displayed for other groups. All of the messages in a group may have the same background color. For example, messages 106 and 136 displayed in message interface 300 may have the same background color because they belong to the same message group. In some implementations, each message group may display a border that distinguishes one message group from another. For example, messages 126 and 128 may be surrounded by a black border having a line thickness that distinguishes the grouping of messages that includes message 126 and message 128 from other message groupings.

According to some implementations, the priority-based message groups may be sorted according to priority. For example, the highest priority group may be displayed near the top of message interface 300 and other lower priority message groups may be displayed below the highest priority group in order of priority. In some implementations, the messages within each group can be sorted according to date received, from, or subject fields, as described above with reference to FIG. 1. The intra-group sorting may be changed by selecting one of the column headers displayed in information area 102, as described with reference to FIG. 1.

According to some implementations, newly received messages can be displayed according to the grouping and sorting techniques disclosed above. In an implementation, when a new message is received, the priority of the message may be determined, and the message may be assigned to a message group corresponding to the determined priority. The message may be displayed within the determined group according to the intra-group sorting techniques disclosed above. For example, when the recipient-user receives a new message as a carbon copy, the priority (e.g., priority level 3) of carbon copy messages may be determined, a message group may be identified based on the priority, and the message may be displayed at the top of the message listing for the group, if intra-group sorting is time ordered with newest messages at the top.

According to some implementations, a recipient-user can configure how messages are to be displayed in a message interface. For example, a user may configure message interface to display messages without addressee based prioritization (e.g., interface 100), with addressee based prioritization and highlighting (e.g., interface 200), with addressee based prioritization and grouping/sorting (e.g., interface 300) or with addressee based prioritization and a combination of highlighting, grouping and sorting. According to some implementations, a recipient-user can configure priority schemes. For example, a recipient-user may configure priorities associated with each of the ways that a recipient can be addressed (e.g., directly addressed, addressed as a group, CC'd, BCC'd, etc.). In some implementations, a recipient-user can configure the highlighting, formatting and/or coloring assigned to each priority level.

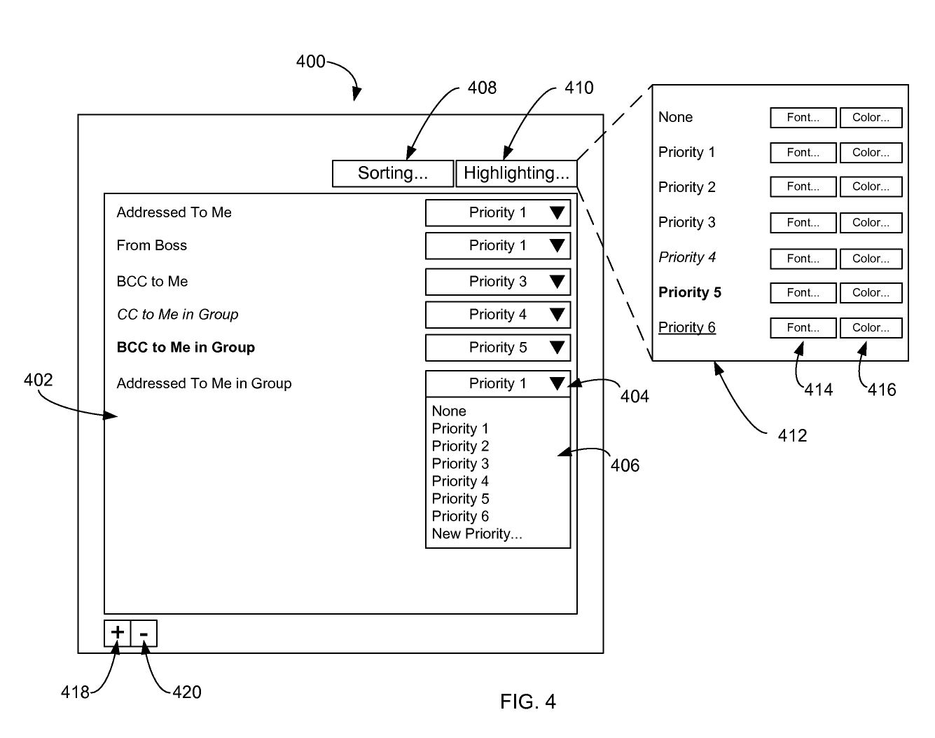

FIG. 4 illustrates an example interface 400 for configuring addressee based message prioritization. For example, interface 400 may be invoked by a user from one of interfaces 100, 200, or 300 through a pull-down menu, button, or other interface element (not shown). Interface 400 can include a display area 402 for displaying priority configuration information. For example, display area 402 may include a list of prioritization rules for various addressing techniques (e.g., how the recipient-user could be addressed in an e-mail, chat message, or other electronic message) or message senders. A user may configure a priority for each prioritization rule listed in display area 402 by selecting a priority from pull-down menu 404. For example, pull-down menu 404 may display a list 406 of priorities available to be assigned to prioritization rules listed in display area 402. Pull-down menu list 406 may include an option for assigning no priority (e.g., “none”). Pull-down menu list 406 may include an option for creating a new priority (e.g., “New Priority . . . ”). If a new priority is created, the new priority may be added to list 406 and displayed when the user selects pull-down menu 404.

Interface 400 can include an interface element 408 for configuring message sorting. For example, a user may select interface element 408 (e.g., a button, pull-down menu, etc.) to display message sorting options (not shown). A user may select to sort, or not sort, messages based on priority, for example. Addressing techniques that do not have a user-assigned priority may be assigned a default priority. For example, the default priority may be the lowest priority available or another default priority configured by the user.

Interface 400 can include an interface element 410 for configuring message highlighting. For example, a user may select interface element 410 (e.g., a button, pull-down menu, etc.) to display message highlighting options interface 412. Interface 412 can display interface elements 414 and 416 that allow the user to select font (414) and background color (416) options to be applied to each message based on priority. For example, the font options may include text formatting, such as font type, color and/or other formatting (e.g., bold, italics, underline, etc.). The background color options may present another interface (not shown) for allowing the user to select a background color to be displayed in the background of message headers based on the priority of the messages. The text of the priorities listed and displayed in interface 412 may be formatted according to the selected font and background color options. For example, if bold text is selected for “Priority 5” then the text for Priority 5 in the priority listing in interface 412 may be displayed in bold font. In some implementations, the highlighting (e.g., font format and background color) may be applied to the addressing techniques listed in display area 402 to give the user a preview of the selected highlighting options for each addressing technique and/or priority.

Interface 400 can include interface element 418 for adding a prioritization rule to the configured prioritization rules listed in display area 402. For example, a user may select interface element 418 to add a new prioritization rule (e.g., how e-mails from the boss should be prioritized or how e-mails addressed directly to the user should be prioritized) to be configured with priority, sorting and highlighting options, as discussed above. Interface 400 can include interface element 420 for removing prioritization rule from the list of configured prioritization rules listed in display area 402. For example, if a prioritization rule for an addressing technique is removed, a default priority (e.g., the lowest priority available) may be assigned to the removed addressing technique and the highlighting associated with the lowest priority may be applied to messages received using the removed addressing technique. In some implementations, if no prioritization rules are configured and displayed in interface 400, addressee based message prioritization may not be applied to messages received and displayed by the electronic messaging application.

### Exemplary Process

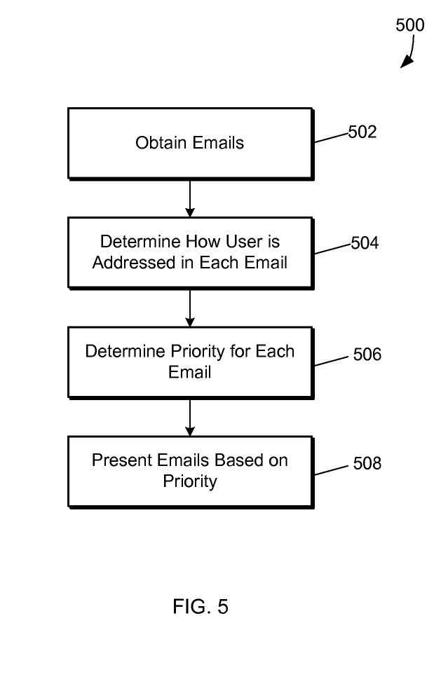

FIG. 5 is flow diagram of an example message prioritization process 400. At step 502, messages are obtained. For example, messages may be obtained from a message server (e.g., e-mail server, chat server) over a network, a local storage device, or a remote storage device. Messages may be obtained in batches or individually as the messages are sent and/or received through the network.

At step 504, each message can be analyzed to determine how the recipient-user is addressed in each message. For example, each message obtained at step 402 may be analyzed to determine which address field of the message contains the recipient-user's address (e.g., account identifier) and how the recipient-user's address was included in the address field. In some implementations, each message can be analyzed to determine if the recipient-user's address appears in the “To” field, the “CC” field, or the “BCC” field of the message. In some implementations, each message can be analyzed to determine whether the recipient-user's address or identifier was included in an address field as a member of a message group or whether the recipient user's address was included in an address field individually or specifically.

At step 506, a priority can be determined for each obtained message based on rules defined by the message application or the user. The rules may be defined by the user through interface 400 of FIG. 4, for example. In some implementations, a priority may be determined based on a mapping of priorities and addressing techniques (e.g., how the recipient-user could be addressed in a message). For example, an addressing technique may be one or more of the following: “to,” “cc,” “bcc,” “to-group,” “cc-group,” “bcc-group,” where to, cc, and bcc indicate that the recipient-user was addressed as an individual in the to, cc, or bcc fields of an message and where “-group” indicates that the recipient-user was addressed as a member of a group in the to, cc or bcc fields. Other addressing techniques can also be used.

In some implementations, each addressing technique can be mapped to a priority. In some implementations, each addressing techniques can be mapped to a different priority. In some implementations, two or more addressing techniques can be mapped to the same priority. According to implementations, the priority mapping can be user-configurable. For example, the user may specify a priority for each addressing technique.

At step 506, messages can be presented on a user interface of an electronic messaging application or device based on the priority determined for each message. For example, the message headers may be highlighted, formatted, colored, grouped and/or sorted based on the priority determined for each message as described above with reference to FIGS. 2-4. In some implementations, the specific highlighting, coloring, formatting, grouping and/or sorting may be specified by the recipient-user. For example, allowing the recipient-user to specify how messages should be presented to the recipient user may allow the recipient-user to quickly and easily identify messages that require immediate attention and response while deferring less urgent messages to a later time.

According to some implementations, other or additional criteria may affect the prioritization of messages received by a recipient-user. In some implementations, a recipient-user may configure the message interface to prioritize messages based on a sender of a message in addition to how the message was addressed to the recipient user. For example, a message addressed to the recipient-user as a carbon copy may be initially determined to have a low priority; however, if the message was sent by the recipient-user's boss at work, the priority of the message may be adjusted to a higher priority and grouped, highlighted and/or sorted according to the adjusted priority. In some implementations, the sender-based priority adjustments may be configured or specified by the recipient-user. For example, a recipient-user may specify the names or message addresses of senders and the priority adjustments that should be applied to messages sent by the specified senders. For example, the recipient user may specify that messages received from “boss@work.com” should be adjusted upward one or more priority levels. In some implementations, the recipient-user may specify a priority for messages sent by a particular message address or sender. For example, the recipient user may specify that all messages from “boss@work.com” should have the highest priority.

According to some implementations, a priority specified by a sender can be used to determine a priority for a message. For example, a message that is blind carbon copied to the recipient-user may be determined to have the lowest priority. However, if the BCC'd message is flagged as important or high-priority by the sender, the sender's prioritization of the message can override the priority determined based on the fact that the recipient-user was BCC'd on the message. For example, a low priority BCC'd message may become a high priority message by virtue of the importance or priority indicated by the sender. In some implementations, the priority assigned to a message by the sender can be used to determine how the message is highlighted, grouped, formatted, and/or sorted, as disclosed above.

### Exemplary System Architecture

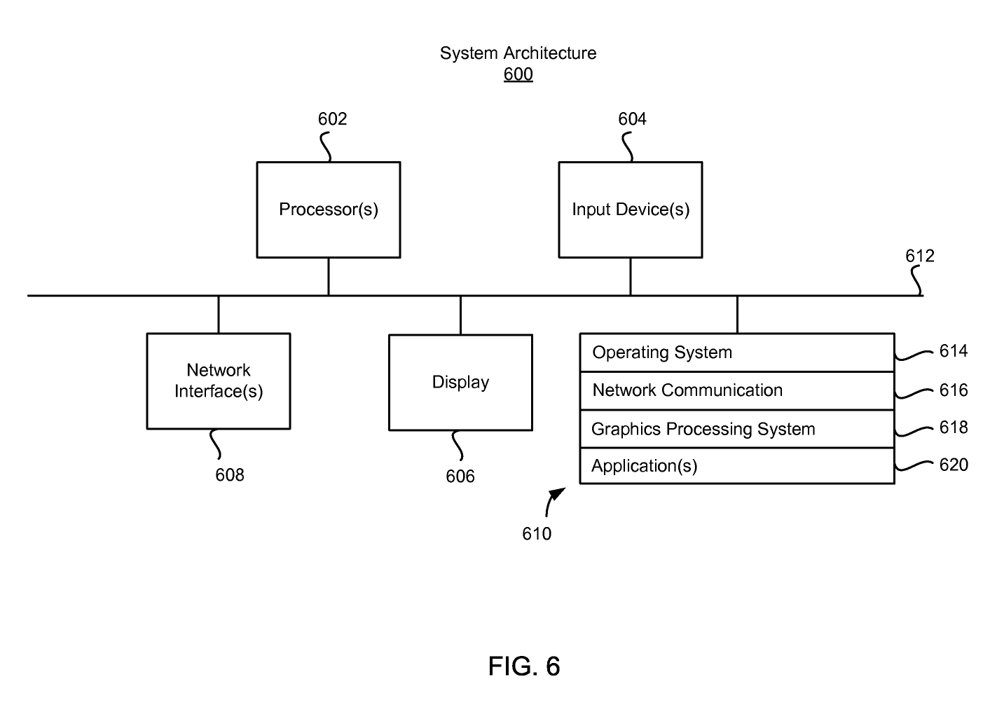

FIG. 6 is a block diagram of an exemplary system architecture implementing the features and processes of FIGS. 1-5. The architecture 600 can be implemented on any electronic device that runs software applications derived from compiled instructions, including without limitation personal computers, servers, smart phones, media players, electronic tablets, game consoles, e-mail devices, etc. In some implementations, the architecture 600 can include one or more processors 602, one or more input devices 604, one or more display devices 606, one or more network interfaces 608 and one or more computer-readable mediums 610. Each of these components can be coupled by bus 612.

Display device 606 can be any known display technology, including but not limited to display devices using Liquid Crystal Display (LCD) or Light Emitting Diode (LED) technology. Processor(s) 602 can use any known processor technology, including but are not limited to graphics processors and multi-core processors. Input device 604 can be any known input device technology, including but not limited to a keyboard (including a virtual keyboard), mouse, track ball, and touch-sensitive pad or display. Bus 612 can be any known internal or external bus technology, including but not limited to ISA, EISA, PCI, PCI Express, NuBus, USB, Serial ATA or FireWire. Computer-readable medium 610 can be any medium that participates in providing instructions to processor(s) 602 for execution, including without limitation, non-volatile storage media (e.g., optical disks, magnetic disks, flash drives, etc.) or volatile media (e.g., SDRAM, ROM, etc.).

Computer-readable medium 610 can include various instructions 614 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 can establish and maintain network connections (e.g., software for implementing communication protocols, such as TCP/IP, HTTP, Ethernet, etc.).

A graphics processing system 618 can include instructions that provide graphics and image processing capabilities. For example, the graphics processing system 618 can generate the electronic messaging user interfaces, as described with reference to FIGS. 1-5. Application(s) 620 can be an electronic messaging application or any other application that uses the processes described in reference to FIGS. 1-5, such as a web browser, e-mail client or chat client. The addressee based message prioritization processes can also be implemented in operating system 614.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed implementations can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
obtaining messages;
determining how each of the messages is addressed;
determining a priority for each of the messages based on how the messages are addressed; and
causing the messages to be displayed on a user interface with a visual indicator of the priority for each message.

2. The method of claim 1, wherein causing the messages to be displayed on a user interface comprises highlighting a message based on the priority determined for the message.

3. The method of claim 2, wherein highlighting comprises formatting text displayed for a message based on the priority determined for the message.

4. The method of claim 2, wherein highlighting comprises displaying a background color in a space associated with a message based on the priority of the message.

5. The method of claim 1, wherein causing the messages to be displayed on a user interface comprises grouping the messages based on the priority determined for each of the messages.

6. The method of claim 1, wherein causing the messages to be displayed on a user interface comprises grouping together messages having the same priority.

7. The method of claim 1, wherein causing the messages to be displayed on a user interface comprises sorting the messages based on the priority determined for the messages.

8. The method of claim 6, wherein causing the messages to be displayed on a user interface comprises sorting groups of messages based on a priority associated with each group.

9. The method of claim 1, wherein determining how each of the messages is addressed to the user comprises determining that the user is addressed individually.

10. The method of claim 1, wherein determining how each of the messages is addressed to the user comprises determining that the user is addressed as a member of a group.

11. The method of claim 1, wherein determining how each of the messages is addressed to the user comprises determining that the user is carbon copied on an message.

12. The method of claim 1, wherein determining how each of the messages is addressed to the user comprises determining that the user is blind carbon copied.

13. The method of claim 1, further comprising:
determining a first priority when the user is addressed individually;
determining a second priority when the user is addressed as a member of a group;
determining a third priority when the user is carbon copied; and
determining a fourth priority when the user is blind carbon copied.

14. A non-transitory computer-readable medium including one or more sequences of instructions which, when executed by one or more processors, causes:
obtaining messages;
determining how each of the messages is addressed;
determining a priority for each of the messages based on how the messages are addressed; and
displaying the messages on a user interface with a visual indicator of the priority for each message.

15. The non-transitory computer-readable medium of claim 14, wherein the instructions that cause displaying the messages on a user interface comprise instructions that cause highlighting a message based on the priority determined for the message.

16. The non-transitory computer-readable medium of claim 14, wherein the instructions that cause displaying the messages on a user interface comprise instructions that cause grouping the messages based on the priority determined for each of the messages.

17. The non-transitory computer-readable medium of claim 14, wherein the instructions that cause displaying the messages on a user interface comprise instructions that cause sorting the messages based on the priority determined for the messages.

18. The non-transitory computer-readable medium of claim 14, wherein the instructions comprise instructions that cause:
determining a first priority when the user is addressed individually;
determining a second priority when the user is addressed as a member of a group;
determining a third priority when the user is carbon copied; and
determining a fourth priority when the user is blind carbon copied.

19. A system comprising:
at least one processor; and
a computer-readable medium including one or more sequences of instructions which, when executed by one or more processors, causes:
obtaining messages;
determining how each of the messages is addressed;
determining a priority for each of the messages based on how the messages are addressed; and
displaying the messages on a user interface with a visual indicator of the priority for each message.

20. The system of claim 19, wherein the instructions comprise instructions that cause:
determining a first priority when the user is addressed individually;
determining a second priority when the user is addressed as a member of a group;
determining a third priority when the user is carbon copied; and
determining a fourth priority when the user is blind carbon copied.
